(19) United States
(12) Patent Application Publication
(10) Pub. No.: US 2023/0286170 A1
(43) Pub. Date: Sep. 14, 2023

(54) ROBOT CONTROL SYSTEM

(71) Applicant: Hitachi, Ltd., Chiyoda-ku, Tokyo (JP)

(72) Inventors: Shogo NAMBA, Tokyo (JP); Yuji Andre YASUTOMI, Tokyo (JP)

(73) Assignee: Hitachi, Ltd., Chiyoda-ku, Tokyo (JP)

(21) Appl. No.: 18/010,406

(22) PCT Filed: Apr. 12, 2021
(86) PCT No.: PCT/JP2021/015160

§ 371 Date: Dec. 14, 2022

(30) Foreign Application Priority Data
Jun. 25, 2020 (JP) 2020-109352

(51) Int. Cl. B25J 13/08; B25J 9/16

(52) U.S. Cl. CPC B25J 13/085; B25J 13/087; B25J 9/1633

(57) ABSTRACT

Provided is a robot control system which can perform force control feedback even when a force sensor has failed. To this end, this robot control system (1) for controlling a robot provided with a force sensor comprises: a force information acquisition unit (11) which acquires force information detected by the force sensor; an electric current information acquisition unit (12) which acquires electric current information from each axial motor of the robot; a force information learning unit (13) which trains a force information estimation model (MF) on the basis of the force information and the electric current information during operation of the robot; a force information estimation unit (15) which estimates force information corresponding to an operation on the basis of the force information estimation model during operation of the robot; and a motor control unit (16) which performs feedback control of each axial motor on the basis of force information acquired by the force information acquisition unit or the force information estimated by the force information estimation unit.

### TECHNICAL FIELD

The present invention relates to a robot control system that estimates force information and weight information from electric current information of a motor by using a physical information estimation model.

### BACKGROUND ART

A robot control system that controls the robot is, for example, a system for controlling driving of a motor attached to a robot arm or a robot hand when changing an arm tip position of the robot arm or causing the robot hand to grip a load. Some robot control systems acquire force information (force and moment) applied to a robot from a force sensor attached to the robot, and perform feedback control on the basis of the force information, and thereby performing danger avoidance control when a robot arm collides with a person or a structure, and gripping operation control of a robot hand in accordance with the weight of a load or the like.

In order to continuously and accurately perform feedback control of a robot, it is required to use a force sensor that is less likely to fail and has high detection accuracy. As the force sensor that satisfies this requirement, an electrostatic capacitance type force sensor that is relatively less likely to fail and has high detection accuracy is known. Since such type of force sensor is more expensive than a strain gauge type force sensor, a method of reducing the number of force sensors used has been studied under an environment where a large number of robots are used.

For example, in the abstract of PTL 1, as a solution for “reducing the number of force sensors used”, the description as follows has been made: “a reference cell 1 including a robot including a force sensor 16 at an arm tip portion performs force sense control for calculating a motor current value by feeding back a force measurement value by the force sensor 16. Then, the reference cell 1 records the correspondence relationship between a work position and the motor current value in reference data 3 during force control. The reference data 3 is set in a copy cell 2 including a robot that does not include a force sensor at an arm tip portion. When a command of force control is given, the copy cell 2 calculates a work position and acquires the motor current value on the basis of the calculated work position and the reference data 3”.

Further, claim 1 of PTL 1 discloses as follows: “a robot cell system including: a first robot cell device including a first robot in which a force sensor is disposed at an arm tip portion; and a second robot cell device including a second robot that does not include a force sensor, the second robot cell device being configured to perform the same operation as an operation of the first robot cell device on a workpiece, in which the first robot cell device includes: a force control unit that performs force control of calculating a current value by feeding back a force measurement value by the force sensor and supplies a current of the calculated current value to the first robot; and a reference data generation unit that generates reference data in which the current value is recorded for each work position while the force control unit is performing the force control, and the second robot cell device includes: a reference data storage unit that stores, in advance, the reference data generated by the reference data generation unit; and a pseudo force control unit that calculates a work position, acquires a current value using the calculated work position and the reference data, and supplies a current of the acquired current value to the second robot when a command of force control is given”.

That is, according to PTL 1, by using the reference data generated by the reference cell (first robot) including the force sensor, the copy cell (second robot) can reproduce the same work as the reference cell without using the force sensor. Thus, it is possible to greatly reduce the number of expensive force sensors used in an environment in which the number of copy cells is large.

### CITATION LIST

### Patent Literature

PTL 1: JP 2014-226752 A

### SUMMARY OF INVENTION

### Technical Problem

However, the copy cell (second robot) in PTL 1 only imitates the work performed in the reference cell (first robot), and cannot independently perform a new work without the reference data. Therefore, when it is desired to cause the second robot to perform a new work, it is necessary to generate new reference data corresponding to the new work in the first robot and then provide the reference data to a control system that controls the second robot. In addition, since the second robot that does not include the force sensor cannot realize the feedback control, there is also a problem that the second robot cannot take the safety avoidance action even though an accident occurs in which a person collides with the second robot during operation, for example.

Therefore, an object of the present invention is to provide a robot control system capable of estimating force information and weight information from electric current information of a motor by using a physical information estimation model, and realizing feedback control based on the estimation information even in a case where a robot in which a force sensor has failed or a robot that does not include a force sensor is set as a control target.

### Solution to Problem

To solve the above problems, an example according to the present invention is a robot control system that controls a robot including a force sensor. The robot control system includes a force information acquisition unit that acquires force information detected by the force sensor, an electric current information acquisition unit that acquires electric current information from each axial motor of the robot, a force information learning unit that trains a force information estimation model on the basis of the force information and the electric current information during an operation of the robot, a force information estimation unit that estimates force information corresponding to an operation on the basis of the force information estimation model during the operation of the robot, and a motor control unit that controls each axial motor on the basis of the force information acquired by the force information acquisition unit or the force information estimated by the force information estimation unit.

Another example according to the present invention is a robot control system that controls a robot including a force sensor. The robot control system includes a force information acquisition unit that acquires force information detected by the force sensor, an electric current information acquisition unit that acquires electric current information from each axial motor of the robot, a weight information learning unit that trains a weight information estimation model on the basis of the force information and the electric current information when the robot grips a load, a weight information estimation unit that estimates weight information corresponding to a load on the basis of the weight information estimation model when the robot grips the load, and a motor control unit that controls each axial motor on the basis of the force information acquired by the force information acquisition unit or the weight information estimated by the weight information estimation unit.

### Advantageous Effects of Invention

According to the robot control system of the present invention, it is possible to estimate force information and weight information from electric current information of a motor by using a physical information estimation model, and to realize feedback control based on the estimation information, even in a case where a robot in which a force sensor has failed or a robot that does not include a force sensor is set as a control target.

### BRIEF DESCRIPTION OF DRAWINGS

FIG. 1 is a diagram illustrating a robot system according to Embodiment 1.

FIG. 2 is a functional block diagram of the robot control system in Embodiment 1.

FIG. 3 is a flowchart of force information learning in Embodiment 1.

FIG. 4 is an explanatory diagram of a force information estimation model MF in Embodiment 1.

FIG. 5 is a functional block diagram of a robot control system according to Embodiment 2.

FIG. 6 is a flowchart of weight information learning in Embodiment 2.

FIG. 7 is a diagram illustrating a weight information estimation model M_{N} in Embodiment 2.

FIG. 8 is a diagram illustrating a robot system according to Embodiment 3.

FIG. 9 is a diagram illustrating a robot system according to Embodiment 4.

### DESCRIPTION OF EMBODIMENTS

Hereinafter, a robot control system 1 according to embodiments of the present invention will be described in detail with reference to the drawings. Note that the present invention is not limited to the embodiments described below. In the drawings used in the following description, common devices and machines are denoted by the same reference numerals, and the description of the devices, machines, and operations described above may be omitted.

### Embodiment 1

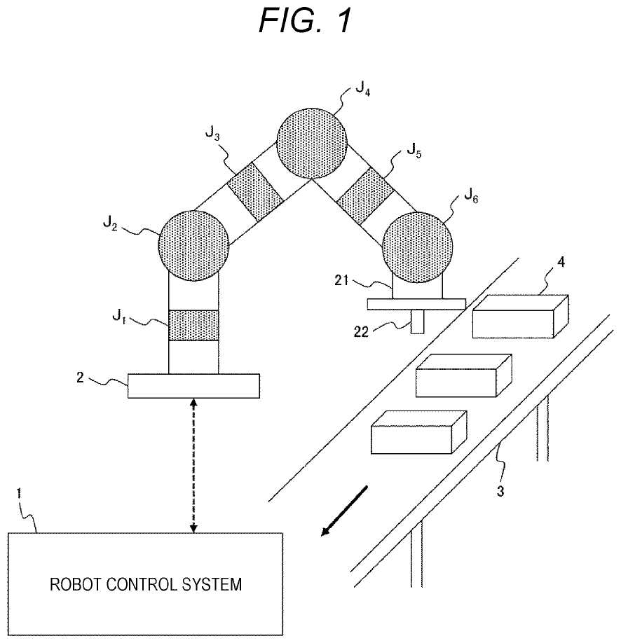

A robot control system according to Embodiment 1 of the present invention will be described with reference to FIGS. 1 to 4.

### [Robot System]

FIG. 1 is a schematic diagram of a robot control system 1 according to Embodiment 1 and a robot system including a robot 2 being a control target of the robot control system 1. The robot 2 described here is a robot arm having six degrees of freedom, and can take any posture by realizing a rotational operation or a torsional operation by an electric motor attached to each of joints J₁ to J₆. Specifically, the electric motor of the robot 2 is a servomotor (simply referred to as a “motor” below), and corresponds to work requiring a high response and a high load. In addition, a rotation angle sensor that outputs rotation angle information is attached in the motor. In the robot control system 1 to which rotation angle information is sequentially input, the rotation angle of each joint J can be measured, and the posture and the arm tip position of the robot 2 can be calculated by forward kinematics. On the contrary, when the robot control system 1 gives a command of the target for the arm tip position to the robot 2, the rotation angle of each joint J of the robot 2 is determined by inverse kinematics.

A force sensor 21 and a picking device 22 are attached to the arm tip of the robot 2. As a result, for example, by attracting a load 4 flowing on a belt conveyor 3 by the picking device 22, it is possible to distribute the load 4 into containers by weight.

A robot arm having six degrees of freedom is illustrated as an example of the robot 2 in FIG. 1, but the degree of freedom is not limited to six, and may be, for example, 7 or 8. Further, the robot 2 may be a robot (for example, a robot hand) other than the robot arm, and the work performed by the robot 2 may also be work other than picking of the load 4 from the belt conveyor 3.

### [Robot Control System 1]

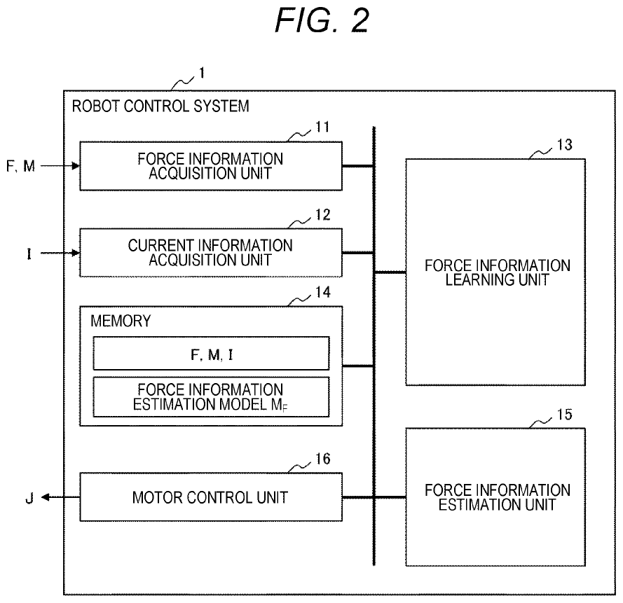

FIG. 2 is a functional block diagram of the robot control system 1 in the present embodiment. As illustrated herein, the robot control system 1 includes a force information acquisition unit 11, an electric current information acquisition unit 12, a force information learning unit 13, a memory 14, a force information estimation unit 15, and a motor control unit 16. Note that the robot control system 1 is specifically a computer including hardware, for example, an arithmetic device such as a CPU, a main storage device such as a semiconductor memory, an auxiliary storage device such as a hard disk, and a communication device. The functions are implemented in a manner that the arithmetic operation device executes a program loaded into the main storage device while referring to data recorded in the auxiliary storage device. Details of each unit will be described below while a well-known technique in the computer field is appropriately omitted.

The force information acquisition unit 11 acquires force information from the force sensor 21. The force information acquired here is, for example, six pieces of information of reaction forces (Fx, Fy, Fz) and moments (Mx, My, Mz) in three axes of X, Y, and Z. The electric current information acquisition unit 12 acquires electric current information I indicating the value of a current flowing in the motor, from a current sensor attached to the motor of each joint J. The force information learning unit 13 performs learning for estimating the force information obtained by the force information acquisition unit 11 on the basis of the electric current information I obtained by the electric current information acquisition unit 12. The memory 14 stores the acquired force information and electric current information I, and a force information estimation model MF trained by the force information learning unit 13. The force information estimation unit 15 estimates the force information from the electric current information I obtained by the electric current information acquisition unit 12, by using the force information estimation model MF. The motor control unit 16 performs force feedback control on the robot 2 by using the force information estimated by the force information estimation unit 15 or the force information acquired by the force information acquisition unit 11.

### [Force Learning Processing]

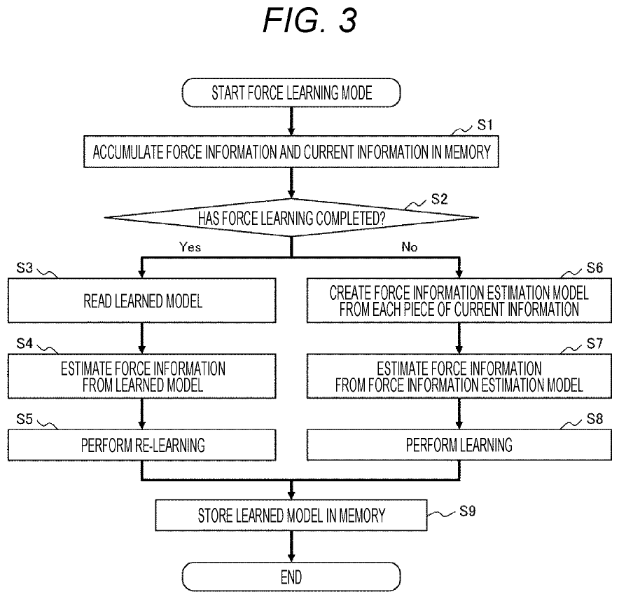

Here, details of learning processing in the force information learning unit 13 will be described with reference to the flowchart in FIG. 3. Note that the learning processing may be performed at regular time intervals or may be performed in response to a command from an operator.

First, in Step S1, the robot control system 1 accumulates the force information obtained by the force information acquisition unit 11 and the electric current information I obtained by the electric current information acquisition unit 12, in the memory 14.

Then, in Step S2, the robot control system 1 reads the memory 14 and checks whether there is a trained force information estimation model MF. When there is the trained force information estimation model MF, it is determined that the force information has been learned in the past, and the process proceeds to Steps S3 to S5. On the other hand, if not, it is determined that the force information has never been learned in the past, and the process proceeds to Steps S6 to S8.

When there is the trained force information estimation model MF, first, in Step S3, the force information learning unit 13 reads the trained force information estimation model MF from the memory 14.

Then, in Step S4, the force information learning unit 13 inputs the electric current information I accumulated in S1 to the trained force information estimation model MF, and estimates the force information.

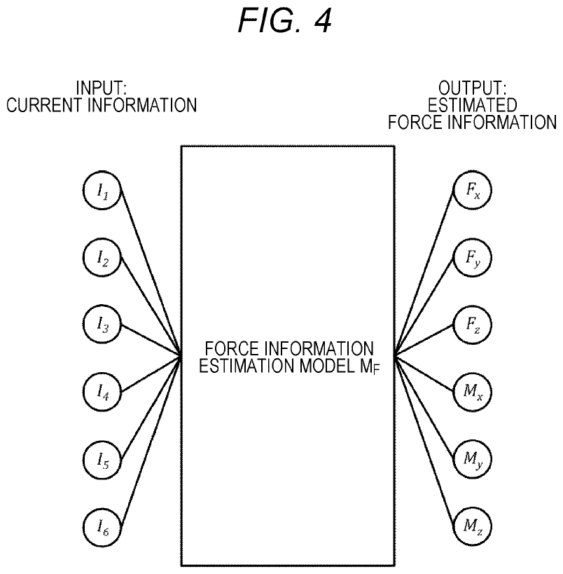

Here, an example of input/output of the force information estimation model MF will be described with reference to FIG. 4. As illustrated herein, the force information estimation model MF in the present embodiment outputs six types of estimated force information including reaction forces of three axes (Fx, Fy, Fz) and moments of three axes (Mx, My, Mz) when pieces of electric current information I₁ to I₆ of the joints J₁ to J₆ of the robot 2 are given.

In Step S5, the force information learning unit 13 performs re-learning by using the force information and the electric current information I acquired in S1 to further improve the accuracy of the force information estimation model M_{F}. The re-learning is performed as follows. That is, the parameter accuracy of the force information estimation model M_{F} is improved by repeating learning by a neural network, which is a type of machine learning, so as to minimize an error between the estimated force information by the electric current information I and the force information estimation model M_{F}, and the force information actually obtained in S1. Note that, in the process of re-learning, a phenomenon called over-learning in which a learning rate decreases when learning is repeated is assumed. In order to avoid an occurrence of such a phenomenon, the learning rate may be sequentially monitored, and a function (dropout) of forcibly ending the learning when the learning rate decreases due to repeated learning may be provided.

Upon completion of Step S5, in Step S9, the force information learning unit 13 stores the force information estimation model M_{F} re-learned in Step S5 in the memory 14.

On the other hand, when there is no trained force information estimation model M_{F}, first, in Step S6, the force information learning unit 13 creates a new force information estimation model M_{F} from the electric current information I of each joint J by the method in FIG. 4.

Then, in Step S7, the force information learning unit 13 inputs the electric current information I accumulated in S1 to the force information estimation model M_{F} created in Step S6, and estimates the force information.

In Step S8, the force information learning unit 13 performs learning by using the force information and the electric current information I acquired in S1. The learning is performed as follows. That is, the parameter accuracy of the force information estimation model M_{F} is improved by repeating learning by a neural network, which is a type of machine learning, so as to minimize an error between the estimated force information by the electric current information I and the force information estimation model M_{F}, and the force information actually obtained in S1. The learning is ended at a stage where the learning is repeated a predetermined number of times or at a stage where the increase in the learning rate is no longer observed.

Upon completion of Step S8, in Step S9, the force information learning unit 13 stores the force information estimation model M_{F} re-learned in Step S8 in the memory 14.

[Behavior during Actual Work]

The force information estimation unit 15 estimates force information from the electric current information I obtained by the electric current information acquisition unit 12 by using the force information estimation model M_{F} stored in the memory 14 by the force information learning unit 13.

The motor control unit 16 performs feedback control of the robot 2 on the basis of the force information acquired by the force information acquisition unit 11 when the output of the force information acquisition unit 11 is normal, and performs feedback control of the robot 2 on the basis of the force information estimated by the force information estimation unit 15 when the output of the force information acquisition unit 11 is abnormal. As a result, even when the force sensor 21 has failed, it is possible to continuously perform the feedback control of the robot 2 by using the estimated force information by the force information estimation unit 15.

As described in detail above, according to the present embodiment, the force information estimation model M_{F} for estimating the force information from the electric current information enables accurate estimation of the force information by inputting the electric current information even when the force sensor has failed after learning, for example. Thus, a danger avoidance behavior at the time of failure is possible as a fail-safe function.

### Embodiment 2

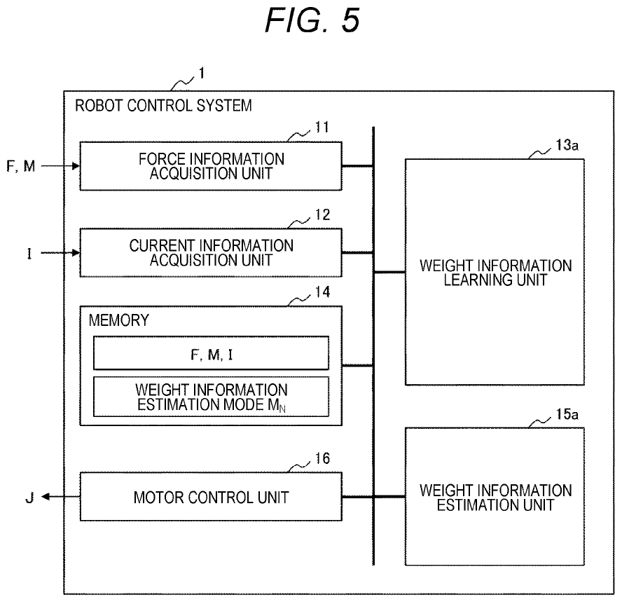

Next, a robot control system according to Embodiment 2 of the present invention will be described with reference to FIGS. 5 to 7. The repetitive description of common points with Embodiment 1 will be omitted.

It is assumed that the robot 2 in the present embodiment performs pick-and-place work of estimating the weight of the lifted loads 4 and sorting the loads 4 by weight.

### [Robot Control System 1]

FIG. 5 is a functional block diagram of a robot control system 1 according to the present embodiment. As illustrated herein, the robot control system 1 includes a force information acquisition unit 11, an electric current information acquisition unit 12, a weight information learning unit 13a, a memory 14, a weight information estimation unit 15a, and a motor control unit 16.

The weight information learning unit 13a performs learning for estimating weight information on the basis of the electric current information I obtained by the electric current information acquisition unit 12. The memory 14 stores the acquired force information and electric current information I, and a weight information estimation model M_{N} trained by the weight information learning unit 13a. The weight information estimation unit 15a estimates the weight information from the electric current information I obtained by the electric current information acquisition unit 12, by using the weight information estimation model M_{N}. The motor control unit 16 causes the robot 2 to perform pick-and-place work by using the weight information estimated by the weight information estimation unit 15a or the force information acquired by the force information acquisition unit 11.

### [Weight Learning Processing]

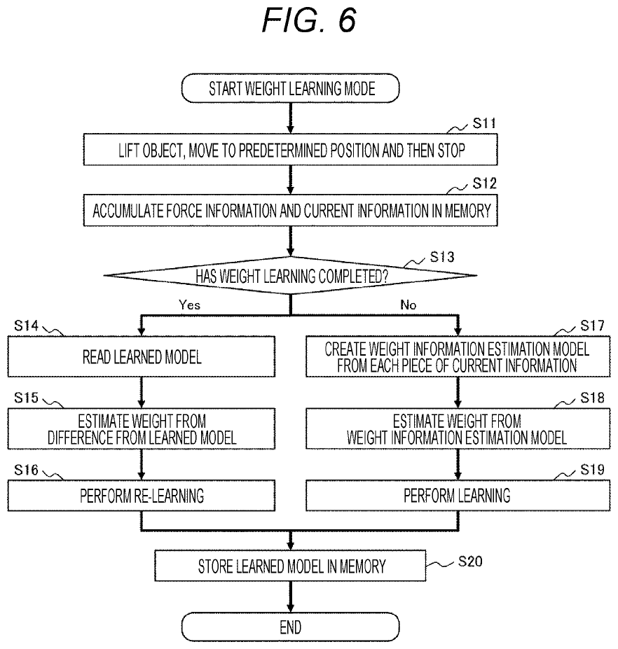

Here, details of learning in the weight information learning unit 13a will be described with reference to the flowchart in FIG. 6. Note that the learning processing herein may be performed at regular time intervals or may be performed in response to a command from an operator.

First, in Step S11, the robot control system 1 causes the robot 2 to lift the load 4, and then causes the robot 2 to perform an operation of moving the load 4 to a predetermined arm tip position P and stop for a minute time. As a result, the electric current information I of the motor of each joint J converges to the steady value, so that the subsequent weight information can be easily estimated. The reason why the arm tip of the robot 2 is moved to the specific arm tip position P is that the posture of each axis and the posture of each node of the robot 2 during weight estimation are set to be the same, so that the manner of applying the own weight to each motor is unified and the weight of the load 4 is accurately estimated.

Here, a relational expression between the electric current information Iᵢ[A] of the motor of each joint Jᵢ (i=1 to 6) and a motor load Tᵢ[N·m] is shown in (Expression 1).

[Math. 1]

Tᵢ=Kᵢ×Iᵢ=Kᵢ×Aᵢ×sin(2πft+θᵢ (Expression 1)

Kᵢ is a motor proportional constant, Aᵢ is an electric current amplitude [A], f is a frequency [Hz], and θⁱ is a phase angle.

In general, the motor load T of each motor of the robot 2 is the sum of a load necessary for the rotation and posture maintenance of the motor, a load necessary for the driving of a speed reduction mechanism, and a load necessary for the self-weight support for each node of the robot 2. Therefore, the motor load due to the weight of the load 4 at the predetermined arm tip position P cannot be obtained by simple calculation of (Expression 1).

Therefore, in the present embodiment, in order to estimate the weight of the load, as shown in (Expression 2), the motor load T_{i,0} when the load 4 (arm tip load) is not held is subtracted from the motor load T_{i,m} when the load 4 (arm tip load) is lifted. Thus, the variation ΔT of the motor torque is extracted, and the weight of the load 4 is estimated on the basis of the variation ΔT.

$$[ Math . 2 ]$$

$$\begin{matrix}Δ {T}_{i , P} = {T}_{i , m} - {T}_{i , 0 =} {K}_{i} \times ( {I}_{i , m} - {I}_{i , 0} ) \\ = {K}_{i} \times \{ {A}_{i , m} \times sin ( 2 π ft + {θ}_{i , m} ) - {A}_{i , 0} \times sin ( 2 π ft + {θ}_{i , 0} ) \}\end{matrix} \qquad ( Expression 2 )$$

ΔT_{i,P} is a motor load variation amount at a predetermined arm tip position P, and I_{i, m} is a motor current [A] when there is the arm tip load. I_{i, 0} is a motor current [A] when there is no arm tip load, A_{i, m} is a motor current amplitude [A] when there is the arm tip load, and A_{i, 0} is a motor current amplitude [A] when there is no arm tip load. θ_{i,m} is a phase angle when there is the arm tip load, and θ_{i,0} is a phase angle when there is no arm tip load. Although the variation ΔT of the motor torque due to the presence or absence of the load 4 is calculated in Expression 2, the variation ΔT of the motor torque when two types of loads 4 having different weights are lifted may be calculated. When the weight information estimation model M_{N} learned from the former is used, it is possible to estimate the absolute weight of the load 4. When the weight information estimation model M_{N} learned from the latter is used, it is possible to estimate the relative weight of the load 4.

Then, in Step S12, the robot control system 1 accumulates the force information obtained by the force information acquisition unit 11 and the electric current information obtained by the electric current information acquisition unit 12, in the memory 14.

In Step S13, the robot control system 1 reads the memory 14 and checks whether there is a trained weight information estimation model M_{N}. When there is the trained weight information estimation model M_{N}, it is determined that the weight information has been learned in the past, and the process proceeds to Steps S14 to S16. On the other hand, if not, it is determined that the force information has never been learned in the past, and the process proceeds to Steps S17 to S19.

When there is the trained weight information estimation model M_{N}, first, in Step S14, the weight information learning unit 13a reads the trained weight information estimation model M_{N}.

Then, in Step S15, the weight information learning unit 13a inputs the electric current information I accumulated in S12 to the trained weight information estimation model M_{N}, and estimates the weight information.

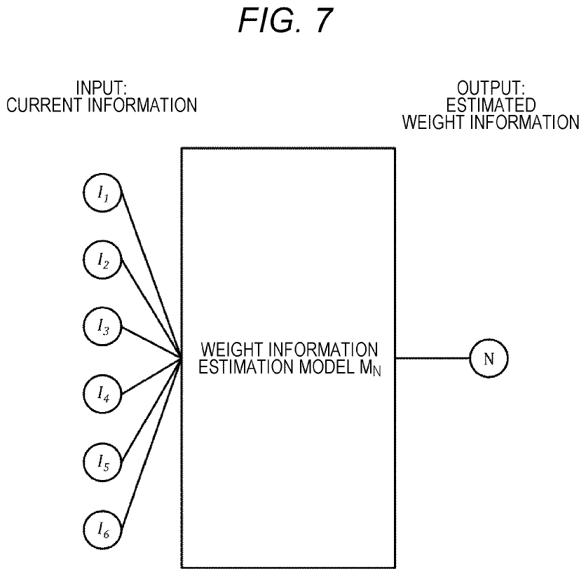

Here, an example of input/output of the weight information estimation model M_{N} will be described with reference to FIG. 7. As illustrated herein, the weight information estimation model M_{N} in the present embodiment outputs the difference N in the reaction force in the Z-axis direction as the gravity information when the pieces of the electric current information I₁ to I₆ of the joints J₁ to J₆ of the robot 2 is given. The difference in the electric current information I of the robot 2 measured at the arm tip position P being the same point becomes apparent as a difference N in the reaction force in a Z-axis direction due to the difference in the arm tip load.

In S16, the weight information learning unit 13a performs re-learning by using the force information and the electric current information I acquired in S11 to further improve the accuracy of the weight information estimation model M_{N}. The re-learning is performed as follows. That is, the parameter accuracy of the weight information estimation model M_{N} is improved by repeating learning by a neural network, which is a type of machine learning, so as to minimize an error of the difference N between the estimated force information by the electric current information I and the weight information estimation model M_{N}, and the force information actually obtained in S11.

Upon completion of Step S16, in Step S20, the weight information learning unit 13a stores the weight information estimation model M_{N} re-learned in Step S16 in the memory 14.

On the other hand, when there is no trained weight information estimation model M_{N}, first, in Step S17, the weight information learning unit 13a creates a new weight information estimation model M_{N} from the electric current information I of each joint J by the method in FIG. 7.

Then, in Step S18, the weight information learning unit 13a inputs the electric current information I accumulated in S12 to the weight information estimation model M_{N} created in Step S17, and estimates the weight information.

In Step S19, the weight information learning unit 13a performs learning by using the force information and the electric current information I acquired in S12. The learning is performed as follows. That is, the parameter accuracy of the weight information estimation model M_{N} is improved by repeating learning by a neural network, which is a type of machine learning, so as to minimize an error of the difference N between the estimated force information by the electric current information I and the weight information estimation model M_{N}, and the force information actually obtained in S12 due to the presence or absence of the arm tip load. The learning is ended at a stage where the learning is repeated a predetermined number of times or at a stage where the increase in the learning rate is no longer observed.

Upon completion of Step S19, in Step S20, the weight information learning unit 13a stores the weight information estimation model M_{N} learned in Step S19 in the memory 14.

[Behavior during Actual Work]

The weight information estimation unit 15a estimates the weight information of the load 4 from the electric current information I obtained by the electric current information acquisition unit 12 using the weight information estimation model M_{N} stored in the memory 14 by the weight information learning unit 13a.

The motor control unit 16 detects the weight of the load 4 on the basis of the force information acquired by the force information acquisition unit 11 when the output of the force information acquisition unit 11 is normal. In addition, the motor control unit 16 estimates the weight of the load 4 by using the weight information estimation unit 15a when the output of the force information acquisition unit 11 is abnormal. As a result, even when the force sensor 21 has failed, it is possible to continuously perform the pick-and-place work of sorting the loads 4 by weight by using the estimated weight information by the weight information estimation unit 15a.

As described in detail above, according to the present embodiment, the weight information estimation model M_{N} for estimating the weight information from the electric current information enables accurate estimation of the weight information by inputting the electric current information even when the force sensor has failed after learning, for example. Thus, a danger avoidance behavior at the time of failure is possible as a fail-safe function.

### Embodiment 3

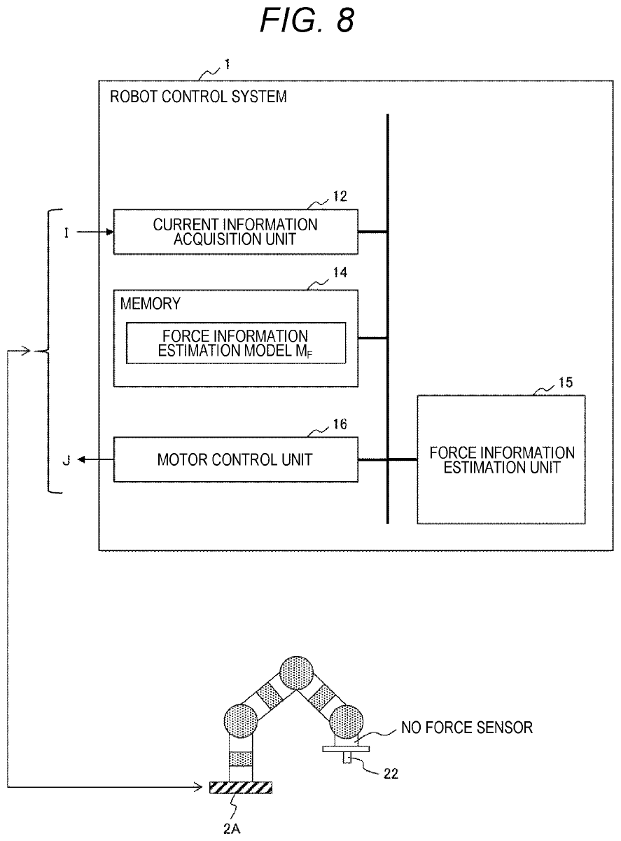

Next, a robot control system according to Embodiment 3 of the present invention will be described with reference to FIG. 8. The repetitive description of common points with the above-described embodiments will be omitted.

The robot 2 including the force sensor 21 is set as the control target in Embodiment 1, but a robot 2A that does not include the force sensor 21 is set as the control target in the present embodiment. Note that the robot 2A has the same specifications as the robot 2 in Embodiment 1 except that the force sensor 21 is not provided.

The force information estimation model M_{F} trained in Embodiment 1 is registered in the memory 14 of the robot control system 1 in the present embodiment. Therefore, the robot control system 1 in the present embodiment can estimate the force information on the basis of the electric current information I acquired from the robot 2A that does not include the force sensor 21, by using the force information estimation model M_{F}, and can realize the feedback control in the robot 2A by using the estimated force information.

Thus, under an environment in which a large amount of the robot 2A that does not include the force sensor 21 is used, it is possible to significantly reduce the number of expensive force sensors used, and to realize a significant cost reduction.

### Embodiment 4

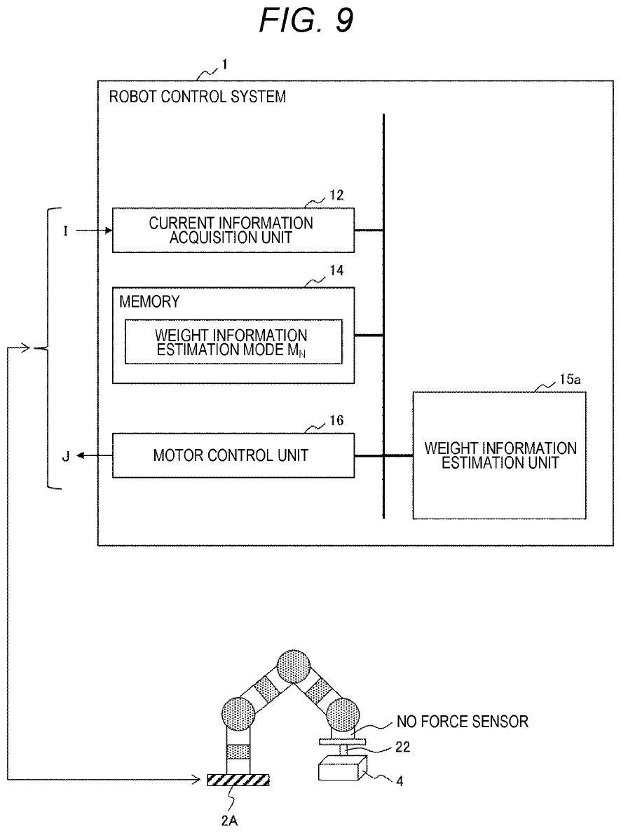

Next, a robot control system according to Embodiment 4 of the present invention will be described with reference to FIG. 9. The repetitive description of common points with the above-described embodiments will be omitted.

The robot 2 including the force sensor 21 is set as the control target in Embodiment 2, but a robot 2A that does not include the force sensor 21 is set as the control target in the present embodiment. Note that the robot 2A has the same specifications as the robot 2 in Embodiment 2 except that the force sensor 21 is not provided.

The weight information estimation model M_{N} trained in Embodiment 2 is registered in the memory 14 of the robot control system 1 in the present embodiment. Therefore, the robot control system 1 in the present embodiment can estimate the weight information on the basis of the electric current information I acquired from the robot 2A that does not include the force sensor 21, by using the weight information estimation model M_{N}, and can cause the robot 2A to perform the pick-and-place work of sorting the loads 4 by weight, by using the estimated weight information.

Thus, under an environment in which a large amount of the robot 2A that does not include the force sensor 21 is used, it is possible to significantly reduce the number of expensive force sensors used, and to realize a significant cost reduction.

### REFERENCE SIGNS LIST

1 robot control system
11 force information acquisition unit
12 electric current information acquisition unit
13 force information learning unit
13a weight information learning unit
14 memory
15 force information estimation unit
15a weight information estimation unit
16 motor control unit
2 robot (with force sensor)
21 force sensor
22 picking device
2A robot (without force sensor)
3 belt conveyor
4 load
M_{F} force information estimation model
M_{N} weight information estimation model

1. A robot control system that controls a robot including a force sensor, the robot control system comprising:
a force information acquisition unit that acquires force information detected by the force sensor;
an electric current information acquisition unit that acquires electric current information from each axial motor of the robot;
a force information learning unit that trains a force information estimation model on the basis of the force information and the electric current information during an operation of the robot;
a force information estimation unit that estimates force information corresponding to an operation on the basis of the force information estimation model during the operation of the robot; and
a motor control unit that controls each axial motor on the basis of the force information acquired by the force information acquisition unit or the force information estimated by the force information estimation unit.

2. The robot control system according to claim 1, wherein
the force information estimation unit estimates force information by inputting the electric current information to the force information estimation model.

3. The robot control system according to claim 1, wherein
feedback control is performed on the robot on the basis of the force information acquired by the force information acquisition unit when an output of the force information acquisition unit is normal, and
feedback control is performed on the robot on the basis of the force information estimated by the force information estimation unit when the output of the force information acquisition unit is abnormal.

4. A robot control system that controls a robot including a force sensor, the robot control system comprising:
a force information acquisition unit that acquires force information detected by the force sensor;
an electric current information acquisition unit that acquires electric current information from each axial motor of the robot;
a weight information learning unit that trains a weight information estimation model on the basis of the force information and the electric current information when the robot grips a load;
a weight information estimation unit that estimates weight information corresponding to a load on the basis of the weight information estimation model when the robot grips the load; and
a motor control unit that controls each axial motor on the basis of the force information acquired by the force information acquisition unit or the weight information estimated by the weight information estimation unit.

5. The robot control system according to claim 4, wherein
the weight information estimation unit estimates weight information by inputting the electric current information to the weight information estimation model.

6. The robot control system according to claim 4, wherein
the robot is controlled on the basis of the force information acquired by the force information acquisition unit when an output of the force information acquisition unit is normal, and
the robot is controlled on the basis of the weight information estimated by the weight information estimation unit when the output of the force information acquisition unit is abnormal.

7. A robot control system that controls a robot that does not include a force sensor, the robot control system comprising:
an electric current information acquisition unit that acquires electric current information obtained from each axial motor during an operation of the robot;
a memory in which a force information estimation model trained by the robot control system according to claim 1 is registered; and
a force information estimation unit that estimates force information by inputting the electric current information during the operation of the robot to the force information estimation model.

8. A robot control system that controls a robot that does not include a force sensor, the robot control system comprising:
an electric current information acquisition unit that acquires electric current information obtained from each axial motor during an operation of the robot;
a memory in which a weight information estimation model trained by the robot control system according to claim 4 is registered; and
a weight information estimation unit that estimates weight information by inputting the electric current information during the operation of the robot to the weight information estimation model.
